(19) United States
(12) Patent Application Publication
(10) Pub. No.: US 2013/0006713 A1
(43) Pub. Date: Jan. 3, 2013

(54) METHOD FOR AGGREGATING PRICING INFORMATION AND ASSIGNING A FAIR MARKET VALUE TO GOODS SOLD IN A PEER-TO-PEER E-COMMERCE TRANSACTION

(76) Inventor: Derek Robert Haake, Akron, OH (US)

(21) Appl. No.: 13/537,012

(22) Filed: Jun. 28, 2012

Related U.S. Application Data
(60) Provisional application No. 61/502,299, filed on Jun. 28, 2011.

(51) Int. Cl. G06Q 30/02

(52) U.S. Cl. 705/7.35

(57) ABSTRACT

A computer-implemented method for aggregating pricing information and assigning a fair market value to goods sold in an ecommerce transaction comprising obtaining pricing information of a good, collecting pricing information of said goods from one or more sources, determining the fair market value of said goods by calculating a weighted mean average of the collected prices, identifying one or more sellers offering to sell said goods, displaying the results of said calculation and said identification using a computerized electronic device.

### CROSS-REFERENCE TO RELATED APPLICATIONS

The present invention claims the priority of provisional patent application Ser. No. 61/502,299 filed on Jun. 28, 2011, the disclosure of which is incorporated herein by reference.

### BACKGROUND OF THE INVENTION

The present invention relates generally to the field of electronic commerce transactions. Specifically, the invention relates to a method and system for aggregating and collecting the prices of a specific good, both inventoried locally and collected from other communication networks (i.e. the Internet), to present the user and the application with a present, fair market value of a good sold online.

Currently software exists in the online community that collects and compares information on pricing, however, no software presently exists to compute and determine a specific market value, such as the fair market value, based upon the pricing information. Most online shopping communities require that users select prices based upon prices set by other people for which they are willing to sell a specific good or service. Furthermore, these communities have no restrictions on what price a user can sell an item, the users have limited information about the value of their product, and users therefore price the item they are selling on ignorance. Users selling products in these online communities then are left guessing at what value to assign their goods, and they are left to randomly guess what the market will allow in many cases. Furthermore, many users will post prices at a much higher level than the market price, or much lower with the intention to either sell faster than everyone else, or to sell their product only when there are no other sellers in the hopes to gouge the eventual buyer. This presents a problem because users will base their information on price, and the price will change, potentially dramatically, between different users in the community.

### SUMMARY OF THE INVENTION

A method and system is taught for aggregating the price of goods sold on a communications network (such as the Internet) with pricing data stored in a database, and a software application that takes this aggregated data and assigns what we feel is a fair market value that is shown to users, prospective buyers and sellers, and utilized within software applications. A user of this system enters an identifying value, such as a UPC code or textbook ISBN, and then the software retrieves information about this item, that is stored within the application's database, and is collected from other external sources (i.e. through scraping, vendor API relationships, and other similar methods). A processor within the central computer then inventories the collected prices. An algorithm is applied to this aggregated data that returns a fair value of the good that was searched, based upon several key variables, and this is displayed either to the user, or used within the application for other purposes. With this fair market value, other variables and parameters are used to adjust the this price up or down, and include, but are not limited to, the reliability of the user (his or her rating) within the community, the condition of the user's product, and the speed at which the user can deliver (i.e. ship or meet in person) the product.

### BRIEF DESCRIPTION OF THE DRAWING

FIG. 1 is a process flow diagram of the initial search step within the invention's software design;

FIG. 2 is a process flow diagram of the price collection step within the invention's software design;

FIG. 3 is a process flow diagram of the fair market value (FMV) calculation step within the invention's software design; and

FIG. 4 is a process flow diagram of the seller identification step within the invention's software design.

### DETAILED DESCRIPTION OF THE INVENTION

The present invention is a computer implemented method for aggregating the price of goods sold on a communications network (such as the Internet). Pricing data stored in a database, and a software application that takes this aggregated data and determines and assigns a fair market value that is shown to users and utilized within software applications. Users are prospective buyers and sellers. A user of this system enters an identifying value, such as a UPC code or textbook ISBN, and then the software retrieves information about this item, that is stored within the application's database, and is collected from other external sources (i.e. through scraping, vendor application programmable interfaces (API) relationships, and other similar methods). A processor within the central computer then inventories the collected prices. An algorithm is applied to this aggregated data that returns what we consider to be a fair market value of the good that was searched, based upon several key variables, and this is displayed either to the user, or used within the application for other purposes.

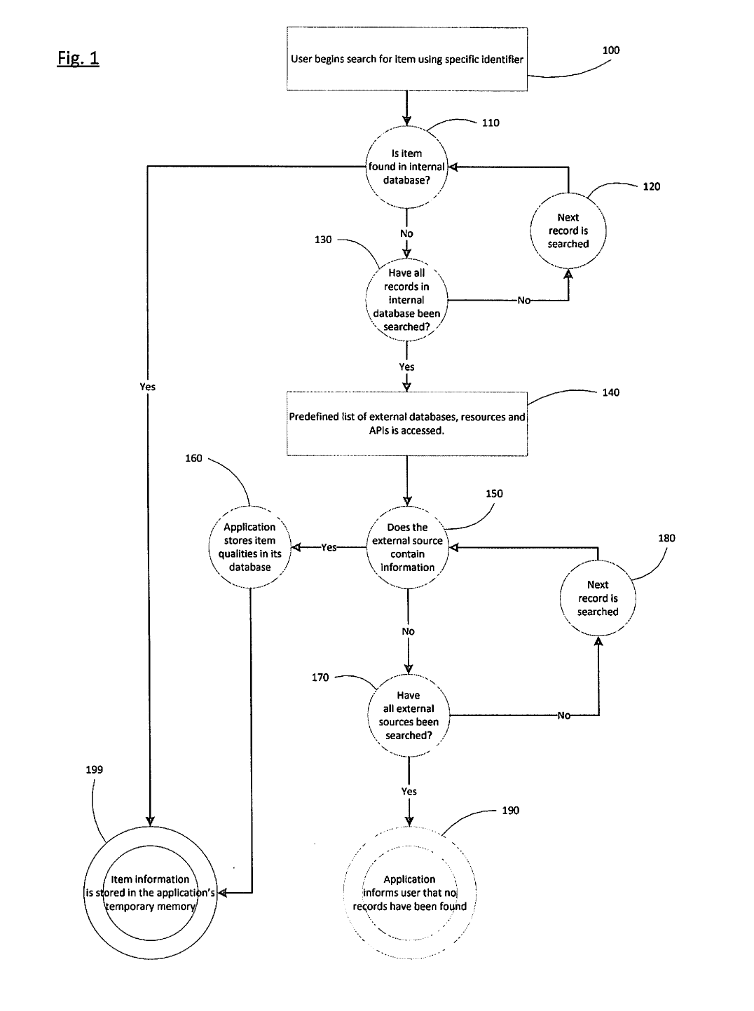

Referring now to the invention in more detail, in FIG. 1 there is shown a detailed process flow for the invention. This process starts when a user decides buy an item from within community. The community is generally any peer-to-peer online or e-commerce marketplace. Examples of e-commerce sites used in the realm of textbook sales include, but are not limited to Amazon, eBay, bookrenter, campusbooks, collegebookrenter, and Alibris. In fields other than books, the application would search suitable appropriate sites. The user inputs a uniquely identifying quality of an item or product into the system 100; this can be an ISBN (international standard book number), UPC (Universal Product Code), or any other specific identifying characteristic, including a year, brand or make and model, or similar quality.

The application then obtains information about the product. This is done by first searching an internal database where information concerning similar items is stored 110. The application loops through each record in the database until a match is found 120 & 130. If no match is found, the software then checks external sources 140.

A list of predefined external sources is entered into the database. The software looks at these sources to find a specific match for the item the user entered 150. These external sources are other databases accessed by application programmable interfaces (APIs), websites where information is scraped and the like. As used herein, the terms “scraped”, “scraping” or “web scraping” (also called web harvesting or web data extraction) mean a computer software technique of extracting information from websites. The application then cycles 180 through each source listed in the application until a record is found 170. If a record is found, the process stops and the data is stored in the database 160. If the application reaches the end of all of the records, then the process terminates, and the user is presented with an error message detailing that no information could be found concerning the UPC, ISBN or other information the user entered 190.

If records are found however, the search terminates as soon as a record is found within the internal system, since the specific item details are now known 160. From here, the information found (whether from the database or through the external searches) is then sorted into specific categories set up in the application that have been defined (for example, condition or edition of a textbook), specific for the type of item that was searched. The application automatically takes these qualities and inserts them into the database with an identifier specific to the user that conducted the initial search 199.

Once the information is stored, the system then displays the results to the user. Here, the user inputs item-specific qualities, such as the overall condition of the item, the quantity of the item, the year, model, color, new or used status, and any other identifying variable that is established in advance for that specific category of item. Once this is done, the process terminates, the item, and the item's characteristics, are now stored in the application's database.

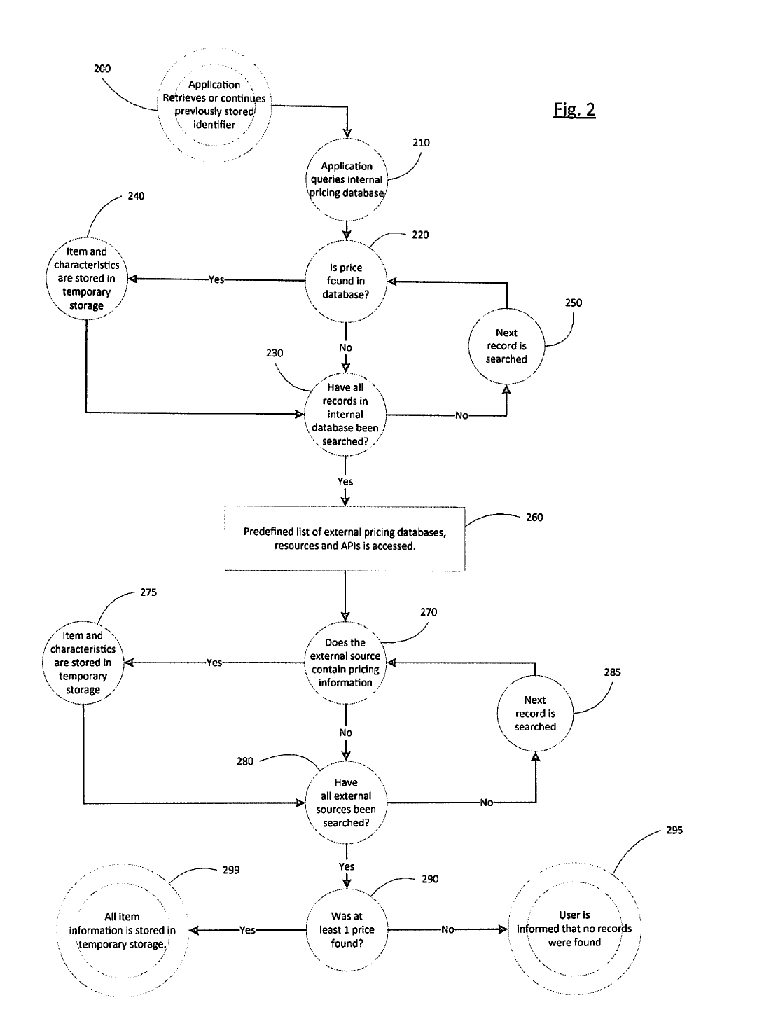

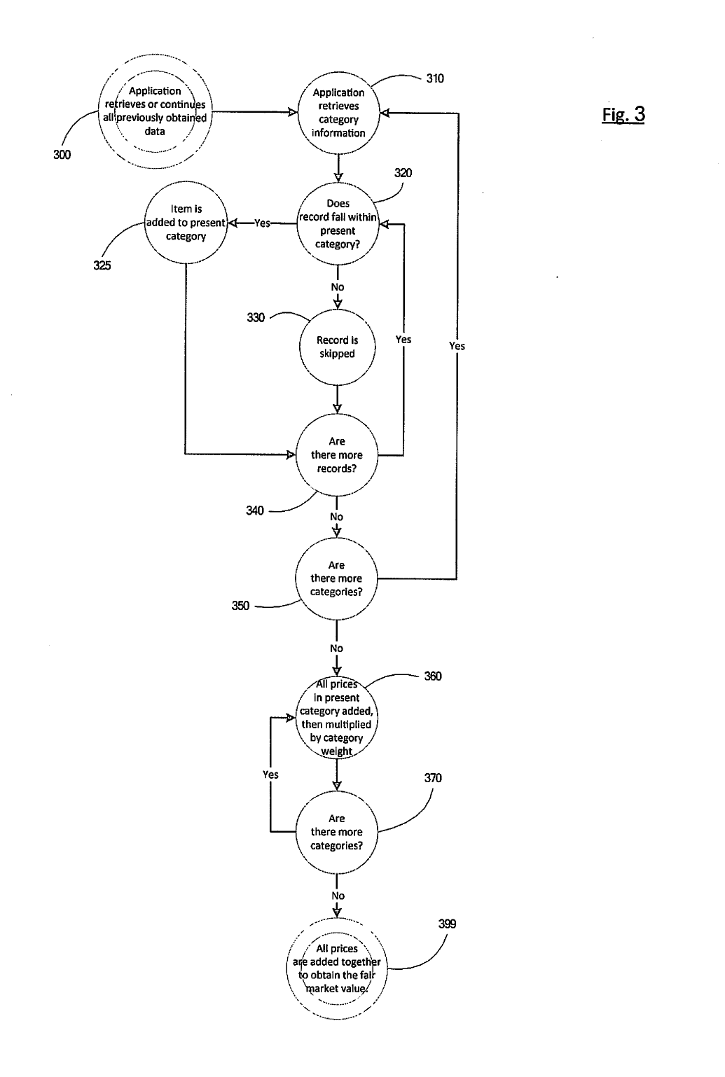

Referring now to the detail in FIG. 2, this is the process whereby another user searches and retrieves the information about an item another user has previously entered, and then stores pricing information retrieved for calculation in a later step (see FIG. 3). This process starts when the application finds descriptive information concerning the item for which a user initially searched 200. The application then takes this identifying quality (UPC, ISBN or other unique characteristic of a specific item) and searches through the application's pricing database for that item 210. The application then goes through each record in the database 220, 250 and retrieves all of those that match the identifier entered by the user. The application stores each one of the records separately 240. After it goes through all of the records 230, if there are no records found, the application displays this to the user 295. If records are found however, the application then looks to find the fair market value.

The application then begins to parse a list of pre-defined websites that it will crawl, scrape and utilize APIs to gather pricing data for the specific item queried 260. As used herein, “crawl” refers to use of a web crawler, which is a computer program that browses the World Wide Web in a methodical, automated manner or in an orderly fashion. Other terms for Web crawlers are ants, automatic indexers, bots, Web spiders, Web robots, or Web scutters. This process is called Web crawling or spidering and many sites, in particular search engines, use it as a means of providing up-to-date data. Web crawlers are mainly used to create a copy of all the visited pages for later processing by a search engine that will index the downloaded pages to provide fast searches. The application accesses this list, and starts processing the pricing, starting at the first record 270. If a price is found, the price, along with specific information about the item, such as its quality, age, condition and so forth are recorded in the application's temporary storage as search data 275, 299. Once a price is found, the application goes back through the target site or API, and searches for another price 280. If a price is not found, then the application moves on to the next website in the predefined list 285. This process is repeated until all of the pre-defined sites, APIs and other information has been depleted by the application.

Referring now to the detail in FIG. 3, the application retrieves previously stored data 300, and then retrieves category information 310. This information is checked to determine whether the record falls within the requisite category 320, and if it does not, it is skipped 330 and the application continues searching records 340. Once all records in a category are exhausted, the application searches for additional categories 350, and if any are found, repeats the above process. Once the application reaches the end of the list, it then groups all of the pricing data together 360. This is done by utilizing a series of pre-defined variables that are collected by the system from other user inputs, and previously defined and quantified by the application administrators, specific to the item being requested. For example, if the item is a textbook, the application will sort prices for new books in a different category than used books.

After the information is sorted, the application will find the mean value of the prices for the specific category. The application will then take the mean value and multiply it by a series of predefined category weights 360, which add to 100%, that have been assigned that is specific for the type of good for which a price is being calculated. The category weights can be determined by manual research, or by allowing for the program to compute it through a looping procedure and some comparative logic. There will be one weight assigned to each category into which the item being priced can fit. Finally, the application will add all of the weighted categories together to derive the fair market value of the good being queried 399. The following example is a calculation we used that resulted in a price that we felt was a fair market price for a textbook:

BookPrice=0.7*[(highest buyback price*0.2)+(0.8* Average Price of all books)].

The 0.7 multiplier turned out to be a significant adjuster to predict a price that ended up giving the seller about 2-3 times the highest buyback price offered, but still let the seller purchase the book within about 5-10% of the lowest cost that they could buy it online.

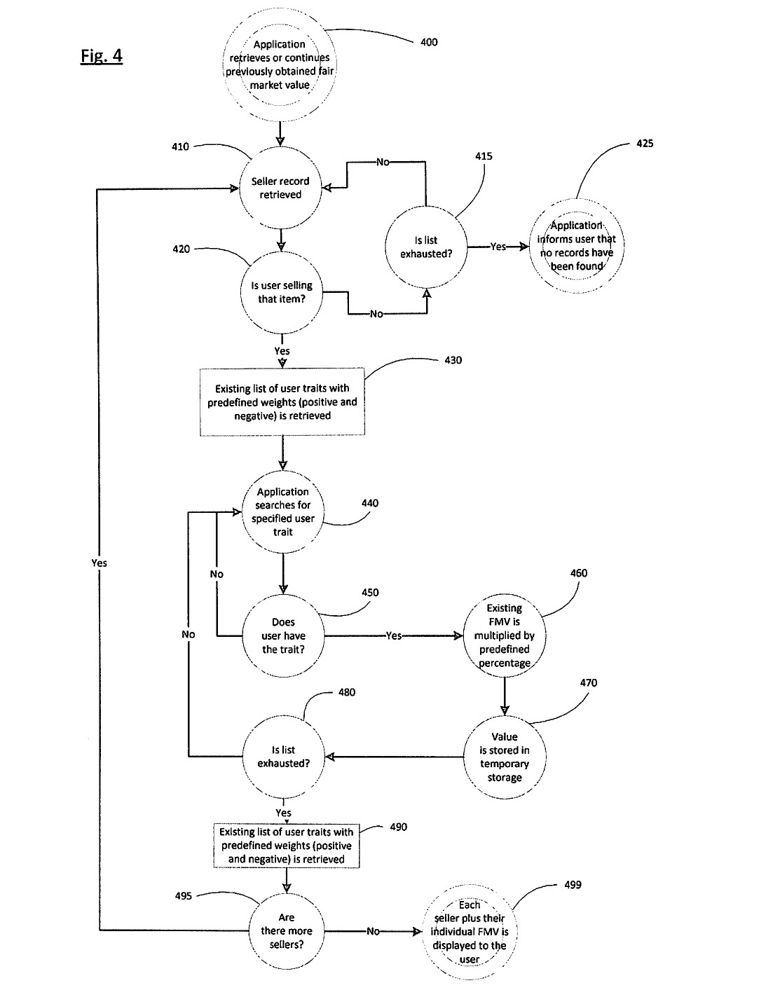

Referring now to the detail in FIG. 4, the application begins by parsing the database 400 and searching for any user, in this case a seller, that previously added a product for sale that matches the identifier or description that a searching party queried 410. The application searches for records containing that identifier 415, 420. If no records are found, it ends the process and notifies the searching user that no records were found 425. If a record is found, the application then stores it in temporary storage. While in temporary storage, the application then gathers other specific, predefined characteristics of the seller, including his or her rating within the community, the distance from the buyer, reliability, and other pre-defined, community-related traits 430. Once these are gathered and accumulated in temporary storage, the application repeats the search until all records in the database have been parsed.

The application then parses the list of users 440, 450 that was collected previously and begins adjusting the price. The application then takes the predefined list of community variables, and multiplies the previously obtained fair market value by the variable that was collected, which is then multiplied by either a negative or positive percent 460 that is assigned to the specific variable. Examples of these community variables include the number of prior transactions in which the user has engaged, the user's rating, a measure of his or her trustworthiness determined by feedback from other users in prior transactions. The application stores this value of the user trait 470 and searches for any additional traits 480. Once all traits have been searched, the application searches for any additional sellers 495. The application then adds all of these individual values and adds it to the previously adjusted fair market value. The application then displays each user individually, the specifics of his or her item, and the adjusted fair market value for each specific good 499. The display is typically via a computer screen, but could also include other means. As used herein, display means a visual report of the results, an audio report, or printed report, including a braille printout for the blind, or combinations thereof.

The advantages of the present invention include, without limitation, that it is simple for a user to use and provides a clear picture of which prices are actually valid within a specific market. Further, this invention applies specifically to books, but is applicable in almost any online commerce transaction where a user posts a product in a peer-to-peer online market. Further, this model creates a simple, price-insensitive approach to a problem that has existed for a long time in the online peer-to-peer marketplace. Further, this process allows pricing to be adjusted based upon condition and other tangible factors of both the user's history and the item's condition, and not an arbitrary pricing scheme that a user fabricates at random. In broad embodiment, the present invention is a method for aggregating and creating a fair market price for an item listed in a peer-to-peer online commerce transaction.

While the present invention could conceivably be used in any ecommerce transaction, the following example using college textbooks is provided to offer some clarification. A user begins by entering the website, and searching by an ISBN. The ISBN does not need to be known. The user can initially perform a keyword search and then select the item that matches their results. The system then uses that item's identifier (ISBN, UPC code, etc.) to perform the other searches.

While this is not the only item that can be compared with the software, it is indicative of providing a product that has a known trait to compare upon (such as a UPC, or a set selection of traits—i.e. an item that is of x brand that is of y color and z size). When the user clicks search, the application queries various online resources (websites, APIs, and other sources where the product information is stored), and retrieves price and other important variables for that product. These variables include such things as condition, edition, etc. Internally previously saved information about that specific product—if it exists—is also retrieved. This information also consists of variables, specific to each product, that have been pre-defined based upon the specific product type being sought—if they exist.

These variables (like condition) are then weighted. This is done based upon user feedback from the website about other identical products (i.e. based on input of an ISBN for a specific book) or of a similar nature, and what that variable does to the product's price (i.e. poor condition lowers by a certain percent whereas excellent condition increases the price by a certain percent). The software also calculates price adjustments based upon statistical averages of the changes in these variables that the application discovers online. These variables are then adjusted and assigned specific weights based upon either pre-defined measures, or other formulae that determine the weights.

After these changes are made, the user is displayed a list of available products sorted by condition, or other characteristics that are deemed appropriate for that good. When the user picks a specific item condition, they then will see a list of users that are selling that item. The application then retrieves specific user data that the application archives (and can also retrieve this from other sources). This information is then assigned specific weights depending on the significance of the trait—for example, how many purchases the user completed, the user's rating (a measure of trustworthiness), and so forth. These weights will provide a score for the user, and then the users that are selling that specific product are ranked. In another variation of this, the prices are further adjusted based upon the user's weighted score, and the price is adjusted by a nominal percentage up and down based upon these specific traits and other social oriented variables.

The application could be executed on a traditional computer or laptop, or it could be in the form of an application (or “app”) for a smartphone (such as an iPhone or a Droid/Android phone) or a tablet (such as an iPad) or the like. It could also be incorporated into a PDA (personal digital assistant) or a stand-alone personal electronic device specifically designed to calculate the fair market value and facilitate such transactions.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What is claimed is:

1. A computer-implemented method for aggregating pricing information and assigning a fair market value to goods sold in an ecommerce transaction comprising:
obtaining pricing information of a good,
collecting pricing information of said goods from one or more sources,
determining the fair market value of said goods by calculating a weighted mean average of the collected prices,
identifying one or more sellers offering to sell said goods,
displaying the results of said calculation and said identification using a computerized electronic device.

2. The method of claim 1 wherein said electronic device is selected from the group consisting of a computer, a laptop, a tablet, a smartphone, a portable digital assistant (PDA), and a portable electronic device.

3. The method of claim 1 wherein said pricing information is obtained using unique identifying product information selected from the group consisting of ISBN, UPC, make or brand, model, year of manufacture, condition, new or used status, age, and color, or combinations thereof.

4. The method of claim 1 wherein said one or more sources comprises one or more internal databases and one or more internet websites having pricing information, whereby when data is collected from said one or more internet websites, said data is recorded and aggregated in said internal database.

5. The method of claim 1 wherein said determining the fair market value of goods is accomplished by
averaging said collected pricing information,
calculating a measure of trustworthiness of the user based on prior interactions with other users using said method, and
modifying said averaged collected pricing information based on said measure of trustworthiness.
